(19) United States
(12) Patent Application Publication
(10) Pub. No.: US 2015/0103065 A1
(43) Pub. Date: Apr. 16, 2015

(54) DISPLAY DEVICE AND METHOD OF OPERATING THE SAME

(71) Applicant: Samsung Display Co., Ltd., Yongin-city (KR)

(72) Inventors: Jung-Taek Kim, Seoul (KR); Cheol-Woo PARK, Suwon-si (KR); Eun-Ho LEE, Suwon-si (KR); Kyoung-Ho LIM, Suwon-si (KR)

(73) Assignee: Samsung Display Co., Ltd., Yongin-city (KR)

(21) Appl. No.: 14/246,852

(22) Filed: Apr. 7, 2014

(30) Foreign Application Priority Data
Oct. 14, 2013 (KR) 10-2013-0121687

(51) Int. Cl. G09G 3/36

(52) U.S. Cl. CPC G09G 3/3614; G09G 2310/0248; G09G 2310/0289
USPC 345/212

(57) ABSTRACT

A display device and a method of operating the same is disclosed. In one aspect, the display device includes a display panel having a plurality of pixels electrically connected to a plurality of data lines and a power supply configured to generate at least one bias voltage. The display device also includes a charge share controller configured to calculate voltage differences between current data voltages and previous data voltages and to generate at least one charge share control signal based on the voltage differences. The display device further includes a data driver configured to selectively perform a charge share operation or a precharge operation based on the charge share control signal. The charge share operation includes electrically connecting at least two of the data lines to each other and the precharge operation includes applying the bias voltage to the data lines.

### CROSS-REFERENCE TO RELATED APPLICATIONS

This application claims priority under 35 USC §119 to Korean Patent Application No. 10-2013-0121687, filed on Oct. 14, 2013 in the Korean Intellectual Property Office (KIPO), the contents of which are incorporated herein in its entirety by reference.

### BACKGROUND

1. Field

The described technology generally relates to a display device and a method of operating the same.

2. Description of the Related Technology

Flat panel displays are being developed to be lighter and thinner than previous flat panel displays. Various types of flat panel displays are produced, such as organic light-emitting diode (OLED) displays, liquid crystal displays (LCDs), and plasma display panels (PDPs).

LCDs operate by generating a voltage difference between a pixel electrode included in each pixel and a common electrode to control the optical transmittance of a liquid crystal layer located between the pixel electrode and the common electrode and thereby display an image. The pixel circuit generally includes at least one thin film transistor (TFT) and a liquid crystal capacitor.

### SUMMARY OF CERTAIN INVENTIVE ASPECTS

One inventive aspect is a display device capable of reducing power consumption and sufficiently charging a data line to prevent deterioration of image quality.

Another aspect is a method of operating a display device capable of reducing power consumption and sufficiently charging a data line to prevent deterioration of image quality.

Another aspect is a display panel having a plurality of pixels connected to a plurality of data lines, a power supply unit configured to generate at least one bias voltage, a charge share controller configured to calculate voltage differences between current data voltages that are to be respectively applied to the data lines and previous data voltages that are respectively applied to the data lines one horizontal period before the current data voltages are applied, and to generate at least one charge share control signal based on the voltage differences, a data driver configured to selectively perform a charge share operation that connects at least two of the data lines to each other or a precharge operation that applies the bias voltage to the data lines in response to the charge share control signal, and to respectively apply the current data voltages to the data lines, and a timing controller configured to control the charge share controller and the data driver.

The charge share controller may be located inside the data driver.

The charge share controller may be located inside the timing controller.

The bias voltage may include a positive bias voltage and a negative bias voltage and during the precharge operation, the data driver may selectively apply the positive bias voltage or the negative bias voltage to each of the data lines based on a polarity of a corresponding one of the current data voltages.

The bias voltage may include a plurality of positive bias voltages and a plurality of negative bias voltages and during the precharge operation, the data driver may apply one of the positive bias voltages or the negative bias voltages to each of the data lines based on a polarity and a voltage level of a corresponding one of the current data voltages.

The data lines may be grouped into a plurality of data line groups each having adjacent N data lines of the plurality of the data lines, where N is an integer of two or more, and for each of the data line groups, a same one of the charge share operation or the precharge operation may be performed.

The charge share controller may include a data voltage comparing unit configured to calculate the voltage differences between the current data voltages and the previous data voltages for the respective data line groups and an initialization decision unit configured to generate the charge share control signal for each of the data line groups based on the voltage differences of the each of the data line groups.

The data voltage comparing unit may include a memory unit configured to store previous image data that has been received one horizontal period before current image data is received and an arithmetic unit configured to convert the current image data into the current data voltages using a look-up table having values of data voltages corresponding to image data, to convert the previous image data into the previous data voltages using the look-up table, and to calculate the voltage differences between the converted current data voltages and the converted previous data voltages.

When all the voltage differences of the data lines included in a same data line group of the data line groups are smaller than a predetermined reference value, the data driver may perform the charge share operation on the same data line group.

When at least one of the voltage differences of the data lines included in a same data line group of the data line groups is greater than a predetermined reference value, the data driver may perform the precharge operation on the same data line group.

The data driver may include a plurality of digital-to-analog converters respectively corresponding to the data lines, the digital-to-analog converters configured to convert current image data into the current data voltages to output the current data voltages, a plurality of precharge switches respectively corresponding to the data lines, each of the precharge switches configured to connect a corresponding one of the data lines to a bias voltage line through which the bias voltage is applied when the precharge operation is performed, to electrically disconnect the corresponding one of the data lines when the charge share operation is performed, and to connect the corresponding one of the data lines to a corresponding one of the digital-to-analog converters after the precharge operation or the charge share operation is completed, and a plurality of charge share switches, at least one of the charge share switches arranged between the data lines included in each of the data line groups, the at least one of charge share switches configured to connect all the data lines included in the each of the data line groups to each other in response to the charge share control signal corresponding to the each of the data line groups.

When the charge share control signal corresponding to the each of the data line groups has a first logic level, the precharge switches corresponding to the each of the data line groups may be turned off and the at least one of charge share switches may connect all the data lines included in the each of the data line groups.

When the charge share control signal corresponding to the each of the data line groups has a second logic level, the precharge switches corresponding to the each of the data line groups may apply the bias voltage to the data lines corresponding to the each of the data line groups, and the at least one of charge share switches corresponding to the each of the data line groups may be turned off.

When the charge share control signal corresponding to the each of the data line groups has a third logic level, the precharge switches corresponding to the each of the data line groups may apply the current data voltages to the data lines corresponding to the each of the data line groups, and the at least one of charge share switches corresponding to the each of the data line groups may be turned off.

Another aspect is a method of operating a display device having a plurality of pixels connected to a plurality of data lines including generating at least one bias voltage, calculating voltage differences between current data voltages that are to be respectively applied to the data lines and previous data voltages that are respectively applied to the data lines one horizontal period before the current data voltages are applied, generating at least one charge share control signal based on the voltage differences, selectively performing a charge share operation that connects at least two of the data lines to each other or a precharge operation that applies the bias voltage to the data lines in response to the charge share control signal, and respectively applying the current data voltages to the data lines.

The bias voltage may include a positive bias voltage and a negative bias voltage and the precharge operation may be performed by selectively applying the positive bias voltage or the negative bias voltage to each of the data lines based on a polarity of a corresponding one of the current data voltages.

The bias voltage may include a plurality of positive bias voltages and a plurality of negative bias voltages and the precharge operation may be performed by applying one bias voltage of the positive bias voltages or the negative bias voltages to each of the data lines based on a polarity and a voltage level of a corresponding one of the current data voltages.

The data lines may be grouped into a plurality of data line groups each having adjacent N data lines of the plurality of the data lines, where N is an integer of two or more, and for each of the data line groups, a same one of the charge share operation or the precharge operation may be performed.

Calculating the voltage differences may include storing previous image data that have been received one horizontal period before current image data are received, converting the current image data into the current data voltages using a look-up table having values of data voltages corresponding to image data, converting the previous image data into the previous data voltages using the look-up table, and calculating the voltage differences between the converted current data voltages and the converted previous data voltages.

The charge share control signal may be generated for each of the data line groups and generating the charge share control signal may include, when all the voltage differences of the data lines included in a same data line group of the data line groups are smaller than a predetermined reference value, generating the charge share control signal having a first logic level to allow the charge share operation to be performed on the same data line group, and when at least one of the voltage differences of the data lines included in a same data line group of the data line groups is greater than a predetermined reference value, generating the charge share control signal having a second logic level to allow the precharge operation to be performed on the same data line group.

Another aspect is a display device including a display panel including a plurality of pixels electrically connected to a plurality of data lines, a controller configured to calculate voltage differences between current data voltages and previous data voltages, and a data driver configured to apply data voltages to the data lines and selectively perform a charge share operation or a precharge operation based at least in part on the voltage differences, wherein the data driver is further configured to electrically connect at least two of the data lines to each other during the charge share operation and wherein the data driver is further configured to apply a bias voltage to the data lines during the precharge operation.

The data lines are divided into a plurality of data line groups and the data driver is further configured to selectively perform the same charge share operation or precharge operation to all of the data lines included in the same data line group. The controller is further configured to determine if all of the voltage differences between the previous and current data voltages applied to the data lines included in a selected one of the data line groups are less than a predetermined reference value and the data driver is further configured to selectively perform the charge share operation or the precharge operation based at least in part on the determination.

The data driver is further configured to apply the previous data voltages to the data lines during a time period which is one horizontal period before the current data voltages.

According to at least one embodiment, a display device, and a method of operating a display may reduce power consumption and may sufficiently charge data lines to prevent the deterioration of image quality by selectively performing the charge share operation or the precharge operation based on the voltage difference between the current data voltages and the previous data voltages.

### BRIEF DESCRIPTION OF THE DRAWINGS

FIG. 1 is a block diagram illustrating a display device according to an embodiment.

FIG. 2 is a block diagram illustrating a display device according to an embodiment.

FIG. 3 is a block diagram illustrating a display device according to an embodiment.

FIG. 4 is a block diagram illustrating an example of a charge share controller included in the display devices of FIGS. 1 to 3.

FIG. 5 is a flow chart illustrating the operation of an initialization decision unit included in a charge share controller.

FIG. 6 is a circuit diagram illustrating an example of a data driver included in the display devices of FIGS. 1 to 3.

FIG. 7A is a diagram illustrating an example in which an unnecessary power loss occurs in a column inversion method.

FIG. 7B is a diagram illustrating an example in which an unnecessary power loss is prevented in a column inversion method according to an embodiment.

FIG. 8 is a diagram illustrating the operation of a display device in a dot inversion method according to an embodiment.

FIGS. 9A and 9B are flow charts illustrating a method of operating a display device according to an embodiment.

FIG. 10 is a block diagram illustrating an electronic system including a display device according to an embodiment.

### DETAILED DESCRIPTION OF CERTAIN INVENTIVE EMBODIMENTS

In general, LCDs regularly invert the polarity of data voltages applied to the pixels to prevent the degradation of the liquid crystal capacitor. Methods of inverting the polarity include dot inversion, row inversion, column inversion, frame inversion, Z-inversion, active level shift (ALS) inversion, etc.

However, the above methods of inverting the polarity can produce problems such as increased power consumption. Furthermore, as the difference between successive voltages applied to a data line increases, there may not be enough time for the applied voltage to reach the target voltage level. Therefore, the data line may not be sufficiently charged, resulting in a degradation of image quality.

Various example embodiments will be described more fully hereinafter with reference to the accompanying drawings, in which some embodiments are shown. The described technology may, however, be embodied in many different forms and should not be construed as limited to the embodiments set forth herein. Rather, these embodiments are provided so that this disclosure will be thorough and complete and will fully convey the scope of the described technology to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the described technology. As used herein, the term “and/or” includes any and all combinations of one or more of the associated listed items.

It will be understood that when an element is referred to as being “connected” or “coupled” to another element, it can be directly connected or coupled to the other element or intervening elements may also be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the described technology. As used herein, the singular forms “a,” “an” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the described technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

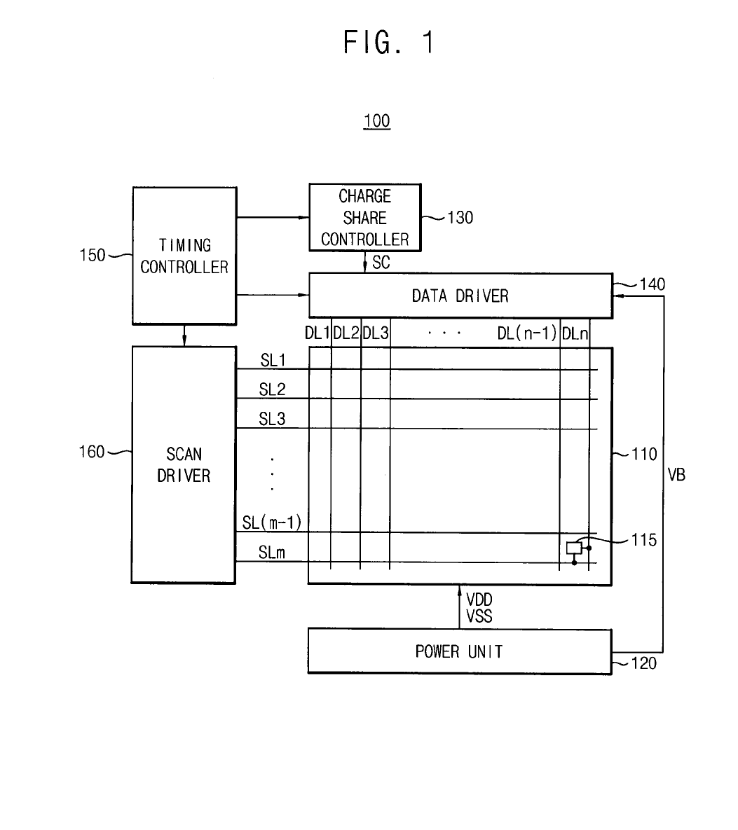

FIG. 1 is a block diagram illustrating a display device according to an embodiment.

In FIG. 1, a display device 100 capable of reducing power consumption and capable of sufficiently charging a data line to prevent deterioration of image quality is illustrated. Referring to FIG. 1, the display device 100 includes a display panel 110, a power supply unit or power supply 120, a charge share controller 130, a data driver 140, and a timing controller 150. In some embodiments, the display device 100 further includes a scan driver 160.

The display panel 110 includes a plurality of pixels 115 connected to a plurality of data lines DL1, DL2, DL3, . . . , DL(n−1), and DLn. The pixels 115 receive data voltages generated by the data driver 140 via the data lines DL1 to DLn. The optical transmittance of each of the pixels 115 is controlled based on the data voltages. The pixels 115 are further connected to a plurality of scan lines SL1, SL2, SL3, . . . , SL(m−1), and SLm.

The power supply unit 120 generates at least one bias voltage VB to be supplied to the data driver 140. In some embodiments, the power supply unit 120 further generates power supply voltages VDD and VSS supplied to the display panel 110. The data driver 140 may perform a precharge operation based on the bias voltage VB supplied from the power supply unit 120. The display panel 110 may display an image by operating the pixels 115 based on the power supply voltages VDD and VSS supplied from the power supply unit 120. In some embodiments, the power supply unit 120 generates one positive bias voltage higher than a predetermined reference voltage (e.g., a common-mode voltage) and one negative bias voltage that is lower than the predetermined reference voltage to be applied as the bias voltage VB. In other embodiments, the power supply unit 120 generates a plurality of positive bias voltages that are higher than a predetermined reference voltage (e.g., a common-mode voltage) and a plurality of negative bias voltages that are lower than the predetermined reference voltage to be applied as the bias voltage VB.

The charge share controller 130 may calculate data voltage differences between current data voltages that are to be respectively applied to the data lines DL1 to DLn and respective previous data voltages that are applied to the data lines DL1 to DLn one horizontal period before the current data voltages are applied. The charge share controller 130 thus generates at least one charge share control signal SC based on the voltage differences. For example, when at least one of the voltage differences is excessively large, there may not be enough time for the voltage of the corresponding data line to reach a target voltage level (e.g., a voltage level of the current data voltage for the corresponding data line). Therefore, the charge share control signal SC may be generated to perform a precharge operation in which the data driver 140 applies the bias voltage VB to the data lines DL1 to DLn. In addition, when all of the voltage differences are small enough, there may be enough time for the voltages of the data lines to reach the target voltage levels. Therefore, the charge share control signal SC may be generated to perform a charge share operation in which the data driver 140 connects at least two of the data lines DL1 to DLn to each other.

In some embodiments, the bias voltage VB includes a plurality of positive bias voltages and a plurality of negative bias voltages and the charge share control signal SC may be generated to selectively apply one of the positive bias voltages or the negative bias voltages to each of the data lines DL1 to DLn based on the polarity and voltage level of the corresponding current data voltage.

In some embodiments, the data lines DL1 to DLn are grouped into a plurality of data line groups each including N data lines of the data lines DL1 to DLn, where N is an integer of two or more. The charge share control signal SC may be generated for each of the data line groups such that each group performs the same charge share operation or precharge operation.

The data driver 140 may selectively perform the charge share operation or the precharge operation in response to the charge share control signal SC. The charge share operation may electrically connect at least two of the data lines DL1 to DLn to each other. The precharge operation may apply the bias voltage VB to the data lines DL1 to DLn. As a result, the necessary power for the voltages of the data lines DL1 to DLn to reach the target voltage levels may decrease due to the charge share operation, thereby decreasing the power consumption of the display device 100. Furthermore, there may be enough time for the voltages of the data lines DL1 to DLn to reach target voltage levels, thereby sufficiently charging the data lines DL1 to DLn. According to some embodiments, the charge share operation or the precharge operation is selectively performed for each of the data line groups based on the charge share control signal SC generated for each of the data line groups. In some embodiments, the bias voltage VB includes a plurality of positive bias voltages and a plurality of negative bias voltages and one of the positive or negative bias voltages is selectively applied to each of the data lines DL1 to DLn based on the charge share control signal SC. The data driver 140 may selectively perform the charge share operation or the precharge operation to initialize the data lines DL1 to DLn and then the current data voltages may be applied to the data lines DL1 to DLn.

The timing controller 150 controls the charge share controller 130 and the data driver 140. The timing controller 150 may further control the scan driver 160. For example, the timing controller 150 may control the timing at which the charge share controller 130 controls the data driver 140 and the timing at which the data driver 140 applies the data voltages to the corresponding data lines DL1 to DLn. The timing controller 150 may further control the timing at which the scan driver 160 applies scan signals to corresponding scan lines SL1 to SLm.

The scan driver 160 may apply the scan signals to the pixels 115 via the scan lines SL1 to SLm. For example, the scan signals may include scan pulses. The data voltages generated by the data driver 140 may be applied to the pixels 115 via the data lines DL1 to DLn, when the scan pulses are applied to the pixels 115.

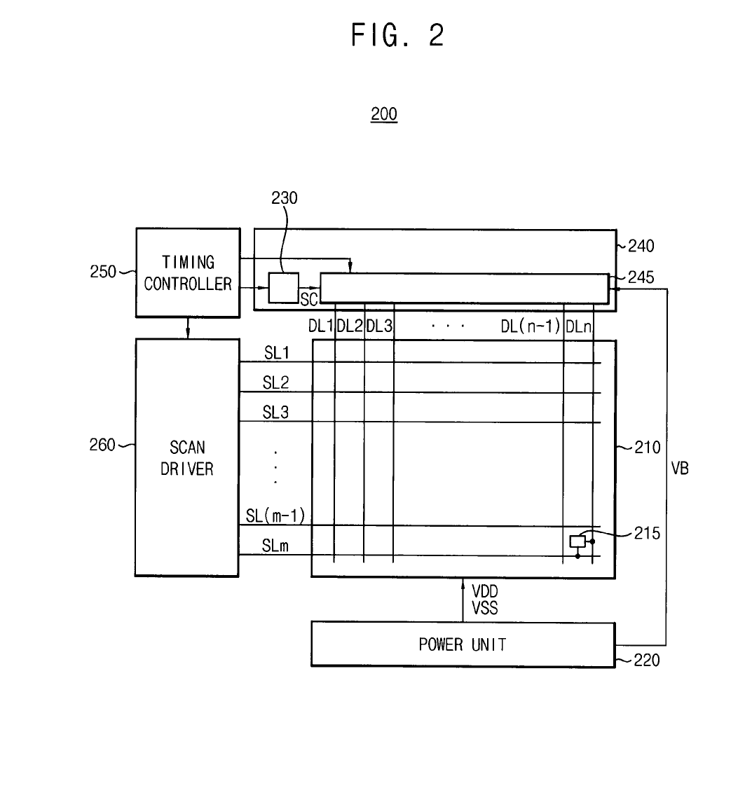

FIG. 2 is a block diagram illustrating a display device according to another embodiment.

Referring to FIG. 2, a display device 200 includes a display panel 210, a power supply unit 220, a data driver 240, and a timing controller 250. The data driver 240 includes a charge share controller 230. In some embodiments, the display device 200 further includes a scan driver 260. Since the configurations of the display panel 210, the power supply unit 220, the timing controller 250, and the scan driver 260 are substantially the same as the configurations of the display panel 110, the power supply unit 120, the timing controller 150, and the scan driver 160 of FIG. 1, duplicated descriptions thereof will not be repeated.

In contrast to the embodiment of FIG. 1, the charge share controller 230 included in the display device 200 of FIG. 2 is included in the data driver 240. Therefore, the data driver 240 may perform the functions of the charge share controller 130 of FIG. 1. For example, the data driver 240 may include the charge share controller 230 and a data line initializing unit or a data line initializer 245 selectively performing a charge share operation and a precharge operation in the same way as described in the data driver 140 of FIG. 1.

The charge share controller 230 included in the data driver 240 may generate at least one charge share control signal SC based on voltage differences between current data voltages and previous data voltages as described in FIG. 1. The data line initializing unit 245 may selectively perform the charge share operation or the precharge operation based on the charge share control signal SC. The charge share operation may electrically connect at least two of the data lines DL1 to DLn to each other. The precharge operation may apply the bias voltage VB to the data lines DL1 to DLn.

As a result, power consumption may be reduced and the data lines DL1 to DLn may be sufficiently charged since the charge share operation and the precharge operation are selectively performed.

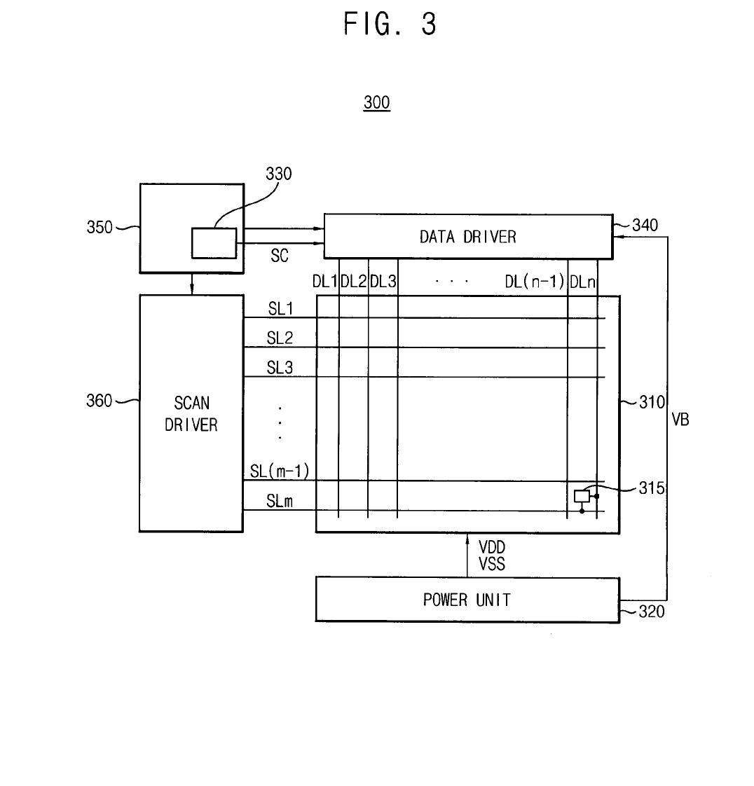

FIG. 3 is a block diagram illustrating a display device according to an embodiment.

Referring to FIG. 3, a display device 300 includes a display panel 310, a power supply unit 320, a data driver 340, and a timing controller 350. The timing controller 350 includes a charge share controller 330. In some embodiments, the display device 300 further includes a scan driver 360. Since the configurations of the display panel 310, the power supply unit 320, the data driver 340, and the scan driver 360 are substantially the same as configurations of the displays panel 110, the power supply unit 120, the data driver 340, and the scan driver 160 of FIG. 1, duplicated descriptions thereof will not be repeated.

In contrast to FIG. 1, the charge share controller 330 included in the display device 300 of FIG. 3 is included in the timing controller 350. Therefore, the timing controller 350 may perform functions of the charge share controller 130 of FIG. 1. For example, the timing controller 350 includes the charge share controller 330 and may control the data driver 340. In some embodiments, the timing controller 350 controls the scan driver 360.

The charge share controller 330 included in the timing controller 350 may generate at least one charge share control signal SC based on voltage differences between current data voltages and previous data voltages as described in FIG. 1. In some embodiments, the charge share controller 330 included in the timing controller 350 generates a single charge share control signal SC. The data diver 340 may perform a charge share operation or a precharge operation in the same way as described in the data driver 140 of FIG. 1 based on the single charge share control signal SC. In these embodiments, the number of signal lines included between the data driver 340 and the timing controller 350 are decreased. In other embodiments, the charge share controller 330 included in the timing controller 350 generates a charge share control signal SC for each of data line groups having a plurality of data lines DL1 to DLn. The data driver 340 may perform a charge share operation or a precharge operation in the same way as described in the data driver 140 of FIG. 1 based on the charge share control signal SC for each of the data groups. In these embodiments, power consumption is reduced and the data lines DL1 to DLn are sufficiently charged by the charge share operation and the precharge operation.

As a result, the power consumption may be reduced and the data lines DL1 to DLn may be sufficiently charged since the charge share operation and the precharge operation are selectively performed.

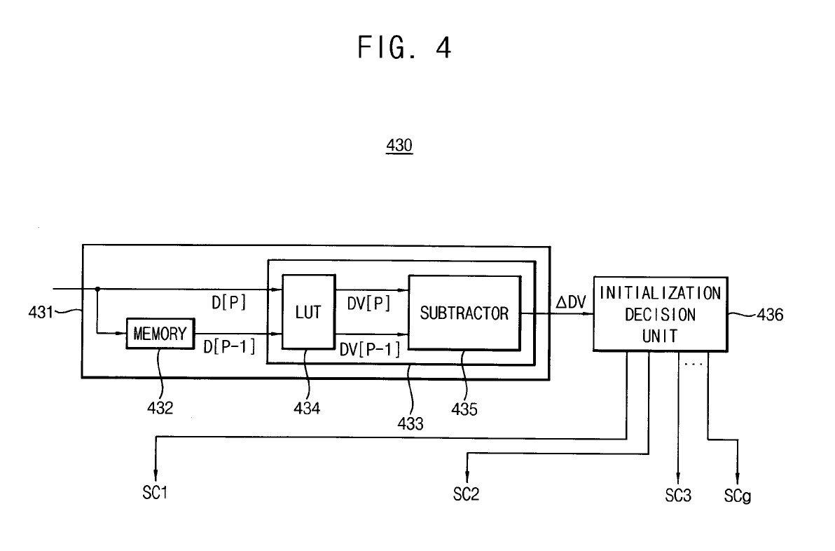

FIG. 4 is a block diagram illustrating an example of a charge share controller included in the display devices of FIGS. 1 to 3.

Referring to FIG. 4, the charge share control unit or charge share controller 430 includes a data voltage comparing unit or data voltage comparator 431 and an initialization decision unit 436. The data voltage comparing unit 431 may calculate voltage differences ΔDV between the current data voltages and the previous data voltages for the respective data line groups. The initialization decision unit 436 may generate a charge share control signal SC1, SC2, SC3, . . . , and SCg for each of the data line groups based on the voltage differences ΔDV of the each of the data line groups. In some embodiments, the charge share controller 130, 230, 330 as illustrated in each of FIG. 1 to FIG. 3 is implemented by the charge share controller 430 of FIG. 4.

According to some embodiments, the data voltage comparing unit 431 includes a memory unit or memory 432 and an arithmetic unit 433. The memory unit 432 may store previous image data D[p−1] received one horizontal period before the current image data D[p]. The arithmetic unit 433 converts the current image data D[p] into current data voltages DV[p] using a look-up table or look-up table memory 434 storing values of the current data voltages DV[p] corresponding to the received current image data D[p]. The arithmetic unit 433 also converts the previous image data D[p−1] into previous data voltages DV[p−1] using the look-up table 434 having values of the previous data voltages DV[p−1] corresponding to the received previous image data D[p−1]. The arithmetic unit 433 calculates the voltage differences ΔDV between the converted current data voltages DV[p] and the converted previous data voltages DV[p−1]. In some embodiments, the initialization decision unit 436 generates the charge share control signals SC1 to SCg for each data line group based on the voltage differences ΔDV.

The memory unit 432 stores the previous image data D[p−1] received one horizontal period before the current image data D[p] and outputs the stored image data D[p−1] when the current image data D[p] is received.

The arithmetic unit 433 converts the current image data D[p] and the stored image data D[p−1] to the current data voltages DV[p] and the previous data voltages DV[p−1], respectively, with reference to the look-up table 434. In some embodiments, the arithmetic unit 433 receives a polarity switching signal including information indicating whether the polarity of the current data voltages DV[p] and the polarity of the previous data voltages DV[p−1] are the same. The arithmetic unit 433 converts the current image data D[p] and the stored image data D[p−1] based on the polarity switching signal, thereby calculating the voltage differences ΔDV between the converted current data voltages DV[p] and the converted previous data voltages DV[p−1]. In some embodiments, the arithmetic unit 433 calculates the voltage differences ΔDV between the current data voltages DV[p] and the previous data voltages DV[p−1] using a subtractor 435.

The initialization decision unit 436 includes logic circuits to determine which level of the charge share control signal SC1 to SCg to generate based on the voltage differences ΔDV calculated by the arithmetic unit 433. In some embodiments, the initialization decision unit 436 generates the charge share control signals SC1 to SCg for each of the data line groups, thereby controlling the corresponding data line groups.

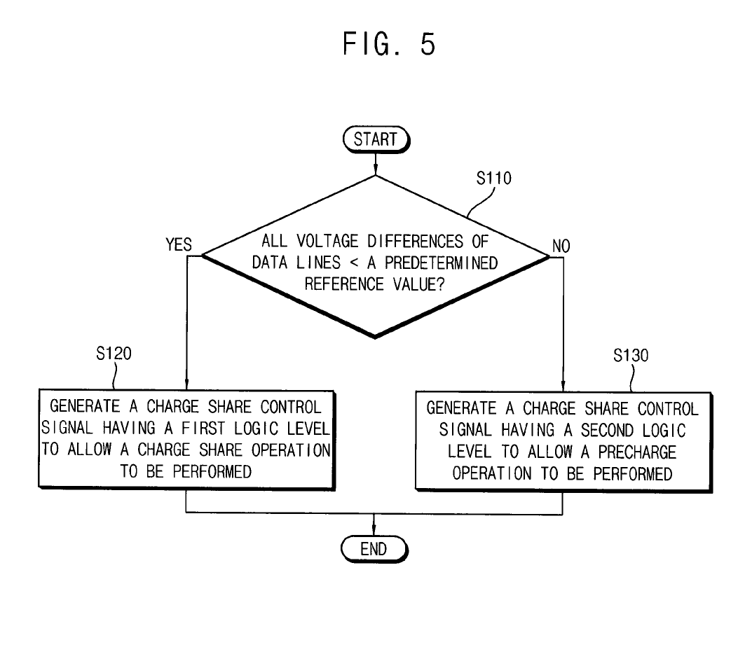

FIG. 5 is a flow chart illustrating the operation of an initialization decision unit included in the charge share controller.

Referring to FIGS. 1 and 5, the initialization decision unit 436 included in the charge share controller 130 determines whether all the voltage differences of the data lines included in the same data line group are less than a predetermined reference value (S110). When all the voltage differences are less than the predetermined reference value, the initialization decision unit generates the charge share control signal SC having a first logic level for the data driver 140 to perform the charge share operation (S120). When at least one of the voltage differences is greater than the predetermined reference value, the initialization decision unit generates the charge share control signal SC having a second logic level for the data driver 140 to perform the precharge operation (S130). The charge share control unit 130 controls the data driver 140 to initialize the data lines DL1 to DLn based on the charge share control signal SC generated by the initialization decision unit. In some embodiments, the charge share control signal SC has a plurality of logic levels that is a combination of two or more bits.

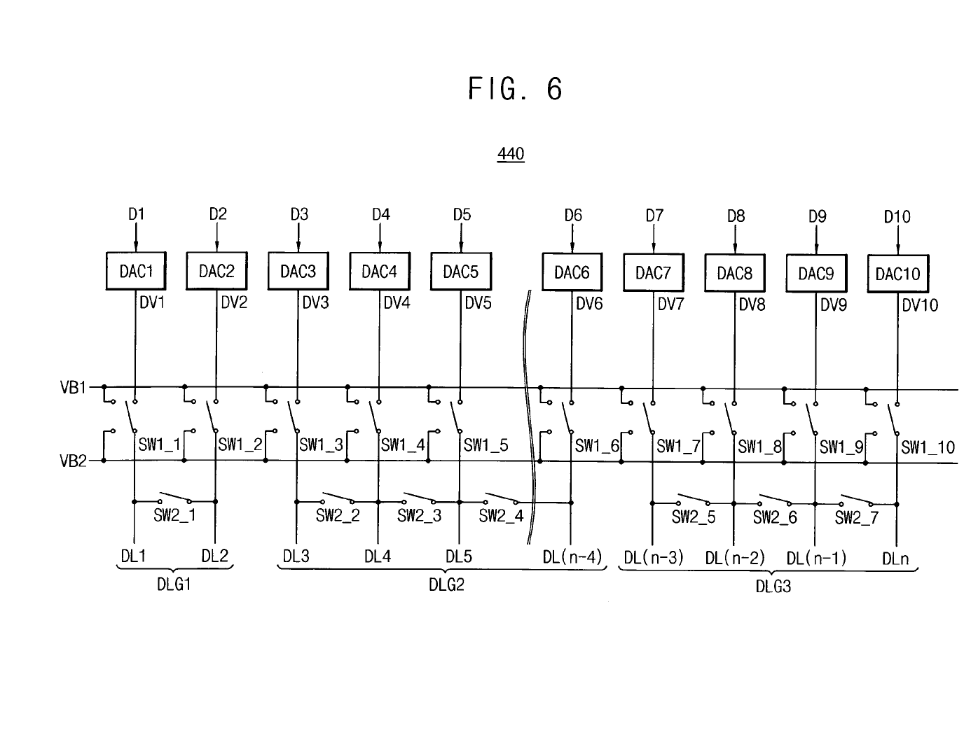

FIG. 6 is a circuit diagram illustrating an example of a data driver included in the display devices of FIGS. 1 to 3.

Referring to FIG. 6, the data driver 440 includes a plurality of digital-to-analog converters DAC1 to DAC10, a plurality of precharge switches SW1_1 to SW1_10, and a plurality of charge share switches SW2_1 to SW2_7. In some embodiments, the data driver 140 as illustrated in FIG. 1, the data driver 240, 340 as illustrated in FIG. 2 and FIG. 3 is implemented by the data driver 440 as illustrated in FIG. 6.

The digital-to-analog converters DAC1 to DAC10 respectively correspond to data lines DL1 to DLn. The digital-to-analog converters DAC1 to DAC10 convert current image data D1 to D10 into the current data voltages DV1 to DV10 and outputs the current data voltages DV1 to DV10. In some embodiments, the digital-to-analog converters DAC1 to DAC10 determine the polarity of the current data voltages DV1 to DV10 based on a polarity switching signal to output the current data voltages DV1 to DV10.

The precharge switches SW1_1 to SW1_10 respectively correspond to data lines DL1 to DLn. Each of the precharge switches SW1_1 to SW1_10 electrically connect a corresponding one of the data lines DL1 to DLn to a bias voltage line through which the bias voltage VB1 and VB2 of FIG. 1 is applied when the precharge operation as illustrated in FIG. 1 is performed. Each of the precharge switches also SW1_1 to SW1_10 disconnects the corresponding data lines DL1 to DLn from the bias voltage line when the charge share operation as illustrated in FIG. 1 is performed. Each of the precharge switches also SW1_1 to SW1_10 also electrically connects the data lines DL1 to DLn to a corresponding after the precharge operation or the charge share operation is completed. The data driver 140 performs the precharge operation by applying the bias voltage VB1 and VB2 to the data lines DL1 to DLn, controls the optical transmittance of a liquid crystal layer included in each pixel by applying the current data voltages DV1 to DV10, and prevents the data driver 440 from damage caused by short circuits in which the digital-to-analog converters DAC1 to DAC10 are connected one another during the charge share operation by disconnecting the data lines DL1 to DLn from the digital-to-analog converters DAC1 to DAC10.

By performing the precharge operation, the voltages of the data lines DL1 to DLn quickly change from the previous data voltages to the bias voltage VB1 or VB2 that is relatively close to the current data voltages DV1 to DV10 to initialize the data lines DL1 to DLn. Thus, the data lines DL1 to DLn may be sufficiently charged to the current data voltages DV1 to DV10 after the initialization.

At least one of the charge share switches SW2_1 to SW2_7 is arranged between the data lines DL1 to DLn included in each data line group, thereby selectively connecting the data lines DL1 to DLn included in the each of the data line groups to each other in response to the charge share control signal SC1 to SCg corresponding to the each of the data line groups. The data lines DL1 to DLn included in each data line group are electrically connected to each other to share charges. For example, since the polarities of two adjacent data lines (e.g. DL1 and DL2) are different from each other in column inversion and dot inversion driving methods, the two adjacent data lines DL1 and DL2 can be initialized to a non-polarized data voltage by the charge share operation.

By performing the charge share operation, since the current data voltages DV1 to DV10 are not applied to the data lines DL1 to DLn during charge sharing, power is not consumed during the initialization. As a result, the power consumption of the display device may be reduced.

For example, when the charge share control signal SC has a first logic level controlling the data driver 440 to perform the charge share operation, the precharge switches SW1_1 to SW1_10 are disconnected from the corresponding data lines DL1 to DLn and the charge share switches SW2_1 to SW2_7 electrically connect the data lines DL1 to DLn included in the each of the data line groups to each other. When the charge share control signal SC has a second logic level controlling the data driver 440 to perform the precharge operation, the precharge switches SW1_1 to SW1_10 electrically connect the corresponding data lines DL1 to DLn to a bias voltage line through which the bias voltage is applied when the precharge operation is performed. During the precharge operation, the charge share switches SW2_1 to SW2_7 disconnect all the data lines DL1 to DLn in the each of the data line groups from each other. When the charge share control signal SC has a third logic level controlling the data driver 440 to apply the current data voltages DV1 to DV10 to each pixel, the precharge switches SW1_1 to SW1_10 electrically connect the data lines DL1 to DLn to corresponding digital-to-analog converters DAC1 to DAC10 to apply the current data voltages DV1 to DV10 converted by the digital-to-analog converters DAC1 to DAC10 to the respective pixels. During the application of the current data voltages DV1 to DV10, the charge share switches SW2_1 To SW2_7 disconnect all the data lines DL1 to DLn in the each of the data line groups from each other.

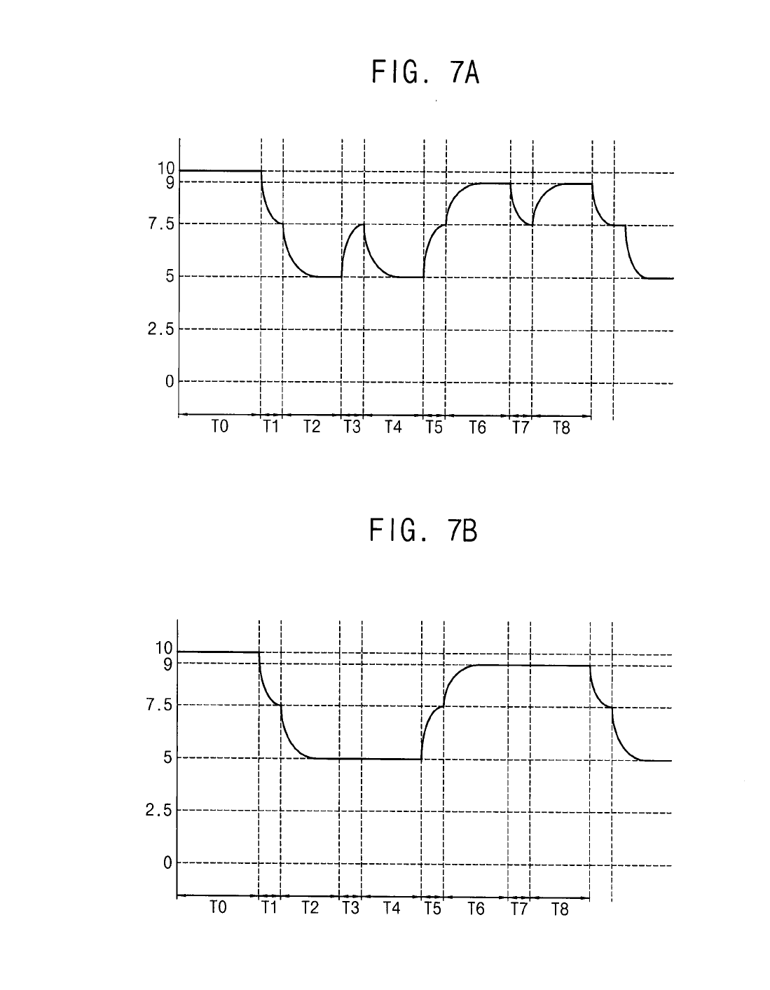

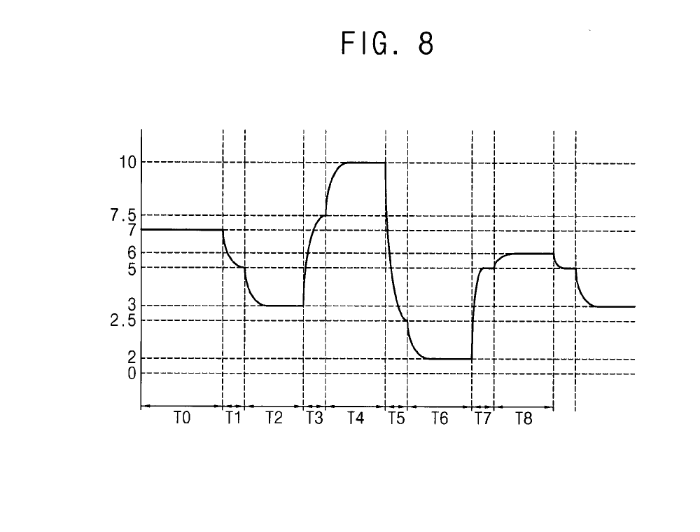

FIG. 7A is a diagram illustrating an example in which unnecessary power loss occurs in a column inversion driving method.

FIG. 7B is a diagram illustrating an example in which unnecessary power loss is prevented in a column inversion driving method according to an embodiment.

Referring to FIGS. 7A and 7B, one horizontal period includes an initialization period T1, T3, T5, and T7, and a data voltage driving period T2, T4, T6, and T8. The common voltage may be set to 5V (i.e. a non-polarized data voltage). The voltage of each data line is initialized during the initialization periods T1, T3, T5, and T7. Data voltages are applied to corresponding data lines during the data voltage driving periods T2, T4, T6, and T8.

In FIG. 7A, the voltages of data lines are initialized to a bias voltage (i.e. 7.5V) for each initialization period T1, T3, T5, and T7 without comparing previous data voltages and current data voltages of the data lines. For example, the voltage of one of the data lines may be initialized to 7.5V during an initialization period T1 without comparing the previous data voltage at T0 (i.e. 10V) and the current data voltage at T2 (i.e. 5V) of the one of the data lines. Therefore, the time required to reach the current data voltage (i.e. 5V) from the previous data voltage (i.e. 10V) may be shortened by the initialization. This may be the same for another case where the data voltage varies from 5V at T4 to 9V at T6.

However, even when the voltage of the data line does not need to vary (e.g. from 5V at T2 to 5V at T4, or from 9V at T6 to 9V at T8), the voltage may be initialized to the bias voltage for each of the initialization periods T1, T3, T5, and T7, resulting in unnecessary power consumption.

In FIG. 7B, when the voltage difference between a current data voltage and a previous data voltage of the data line is less than a predetermined reference value, the voltages of the one of the data lines is not initialized to a bias voltage as described in FIG. 7A. Accordingly, unnecessary power consumption does not occur. For example, when the predetermined reference value is 4V, the data lines is not initialized to the bias voltage during T3 and T7 since the voltage differences are both less than 4V.

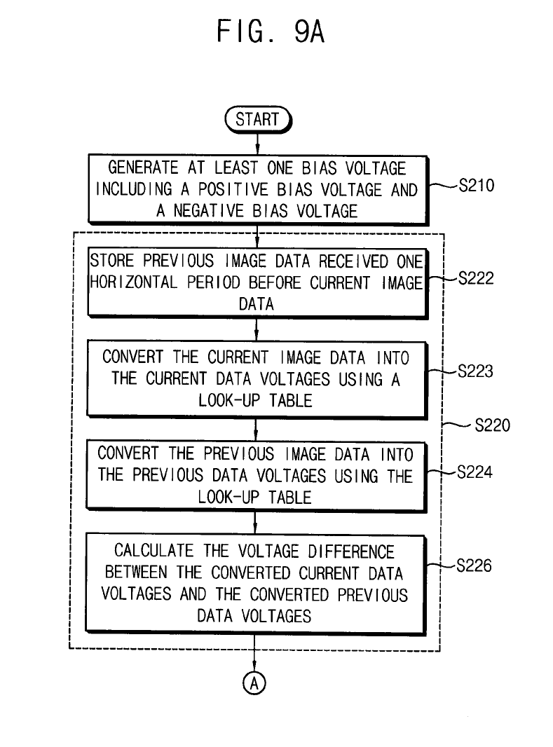

FIG. 8 is a diagram illustrating the operation of a display device in a dot inversion method according to an embodiment.

Referring to FIG. 8, one horizontal period includes an initialization period T1, T3, T5, and T7, and a data voltage driving period T2, T4, T6, and T8. The common voltage is set to 5V (i.e. a non-polarized data voltage). The voltage of each data line is initialized during the initialization periods T1, T3, T5, and T7. Data voltages are applied to corresponding data lines during the data voltage driving periods T2, T4, T6, and T8.

When the voltage difference between a current data voltage and a previous data voltage of one of the data lines is less than a predetermined reference value, the data driver performs a charge share operation during a corresponding initialization period since there is enough time to reach the current data voltage. As a result, the data line may return to a non-polarized voltage level, and power is not consumed during the charge share operation. For example, when the predetermined reference value is 5V, the data driver may perform the charge share operation during T1 and T7 since the voltage differences are both less than 5V.

When the voltage difference between the current data voltage and the previous data voltage of the data line is greater than the predetermined reference value, the data driver performs a precharge operation applying a bias voltage based on the polarity of the current data voltage during a corresponding initialization period since there may not be enough time to reach the current data voltage. As a result, the data line is sufficiently charged due to the precharge operation. For example, when the predetermined reference value is 5V, the data driver may perform the precharge operation during T3 and T5 since the voltage differences are both greater than 5V.

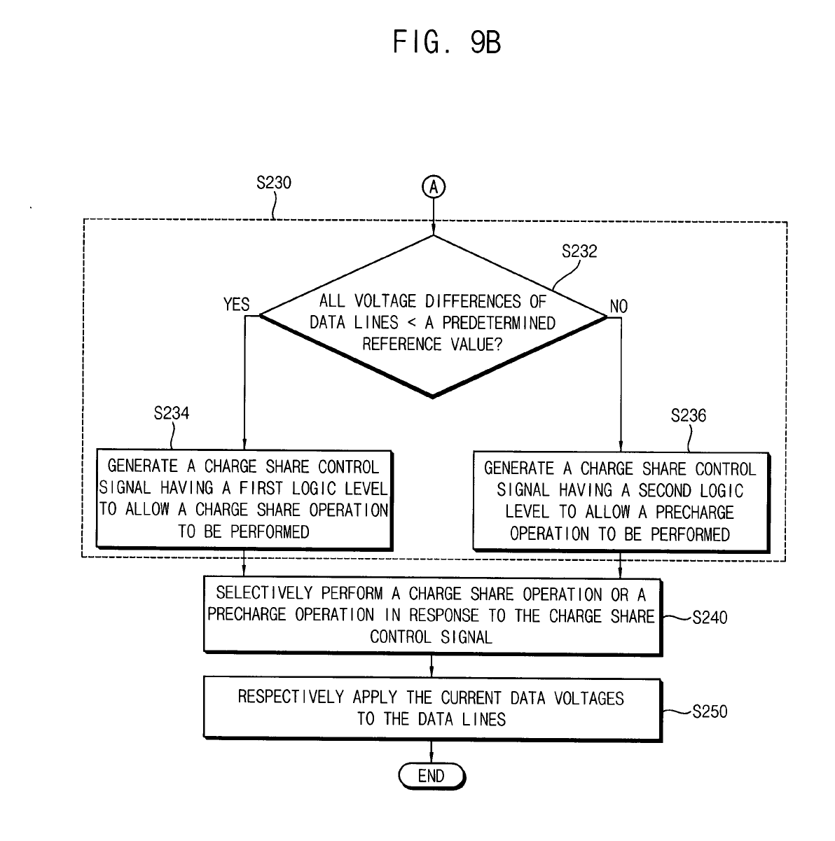

FIGS. 9A and 9B are flow charts illustrating a method of operating a display device according to an embodiment.

Referring to FIGS. 9A and 9B, at least one bias voltage is generated (S210) and then voltage differences between current data voltages and previous data voltages are calculated (S220). The current data voltages are data voltages that are currently applied to the data lines and the previous data voltages are data voltages that are previously applied to the data lines one horizontal period before the current data voltages are applied. At least one charge share control signal is generated based on the voltage differences (S230) and then a charge share operation or a precharge operation is selectively performed in response to the charge share control signal (S240). The charge share operation electrically connects at least two of the data lines to each other and the precharge operation applies the bias voltage to the data lines. Finally, the current data voltages are respectively applied to the data lines (S250).

In some embodiments, to calculate the voltage differences between the current data voltages and the previous data voltages (S220), previous image data received one horizontal period before the current image data is stored (S222), the current image data is converted into current data voltages using a look-up table having values of the data voltages corresponding to the image data (S223), the previous image data is converted into previous data voltages using the look-up table (S224), and then the voltage differences between the converted current data voltages and the converted previous data voltages is calculated (S226).

In some embodiments, the charge share control signal may have a plurality of logic levels that is a combination of two or more bits. It is determined whether all of the voltage differences of the data lines included in each data line group are less than a predetermined reference value (S232). The charge share control signal is generated (S230) such that the charge share control signal has a first logic level to allow the charge share operation to be performed on each data line group when all the voltage differences of the data lines included in the data line group are less than a predetermined reference value (S234) and the charge share control signal has a second logic level to allow the precharge operation to be performed on each data line group when at least one of the voltage differences of the data lines included in the data line group is greater than the predetermined reference value (S236).

In some embodiments, the data lines are grouped into a plurality of data line groups each having adjacent N data lines, where N is an integer of two or more. The charge share operation or the precharge operation is selectively performed for each data line group and the same charge share operation or precharge operation is performed for each data line included in the same data line group (S240).

In some embodiments, the bias voltage includes a positive bias voltage and a negative bias voltage. The precharge operation is performed by selectively applying the positive bias voltage or the negative bias voltage to each of the data lines based on the polarity of a corresponding one of the current data voltages.

In other embodiments, the bias voltage includes a plurality of positive voltages and a plurality of negative voltages. The precharge operation is performed by applying one of the bias voltages to each of the data lines based on the polarity and the voltage of the corresponding current data voltage.

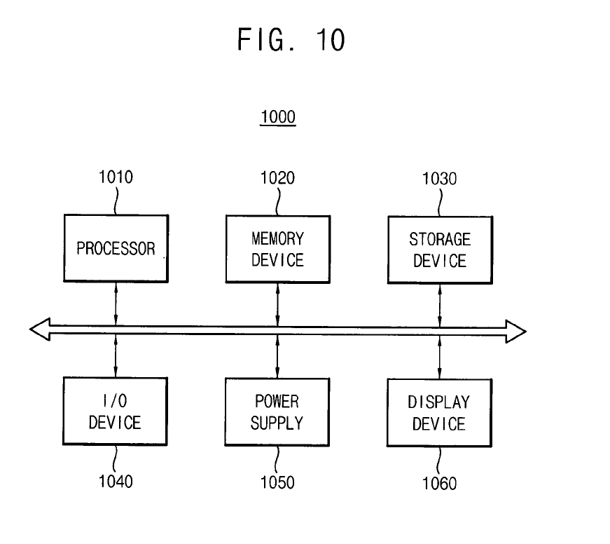

FIG. 10 is a block diagram illustrating an electronic system including a display device according to an embodiment.

Referring to FIG. 10, an electronic system 1000 includes a processor 1010, a memory device or memory 1020, a storage device 1030, an input/output (I/O) device 1040, a power supply 1050, and a display device or display 1060. The electronic system 1000 may further include a plurality of ports for communicating with a video card, a sound card, a memory card, a universal serial bus (USB) device, other electronic systems, etc.

The processor 1010 may perform various computing functions or tasks. The processor 1010 may be for example, a microprocessor, a central processing unit (CPU), etc. The processor 1010 may be connected to other components via an address bus, a control bus, a data bus, etc. Further, the processor 1010 may be connected to an extended bus such as a peripheral component interconnection (PCI) bus.

The memory device 1020 may store data for the operations of the electronic system 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile dynamic random access memory (mobile DRAM) device, etc.

The storage device 1030 may be, for example, a solid state drive (SSD) device, a hard disk drive (HDD) device, a CD-ROM device, etc. The I/O device 1040 may be, for example, an input device such as a keyboard, a keypad, a mouse, a touch screen, etc, and/or an output device such as a printer, a speaker, etc. The power supply 1050 may supply power for operations of the electronic system 1000. The display device 1060 may communicate with other components via the buses or other communication links.

The display device 1060 may include a display panel, a power supply unit, a charge share controller, a data driver, and a timing controller. The charge share controller may calculate voltage differences between current data voltages that are to be respectively applied to the data lines and previous data voltages that are respectively applied to the data lines one horizontal period before the current data voltages are applied, thereby generating at least one charge share control signal based on the voltage differences. The data driver may selectively perform a charge share operation that connects at least two of the data lines to each other or a precharge operation that applies the bias voltage to the data lines in response to the charge share control signal and then may respectively apply the current data voltages to the data lines.

Thus, the display device 1060 may reduce power consumption and may sufficiently charge the data line to prevent image quality deterioration by selectively performing the charge share operation or the precharge operation based on the voltage difference between the current data voltages and the previous data voltages.

The present embodiments may be applied to any electronic system 1000 having the display device 1060. For example, the present embodiments may be applied to an electronic system 1000 such as a television, a computer monitor, a laptop, a digital camera, a cellular phone, a smart phone, a personal digital assistant (PDA), a portable multimedia player (PMP), an MP3 player, a navigation system, a video phone, etc.

The foregoing is illustrative of exemplary embodiments and is not to be construed as limiting thereof. Although a few embodiments have been described, those skilled in the art will readily appreciate that many modifications are possible in the embodiments without materially departing from the novel teachings and advantages of embodiments. Accordingly, all such modifications are intended to be included within the scope of embodiments as defined in the claims. In the claims, means-plus-function clauses are intended to cover the structures described herein as performing the recited function and not only structural equivalents but also equivalent structures. Therefore, it is to be understood that the foregoing is illustrative of embodiments and is not to be construed as limited to the specific embodiments disclosed, and that modifications to the disclosed embodiments, as well as other embodiments, are intended to be included within the scope of the appended claims. The described technology is defined by the following claims, with equivalents of the claims to be included therein.

What is claimed is:

1. A display device, comprising:
a display panel including a plurality of pixels electrically connected to a plurality of data lines;
a power supply configured to generate at least one bias voltage;
wherein the display device is configured to i) calculate voltage differences between current data voltages associated with current image data and previous data voltages associated with previous image data and ii) generate at least one charge share control signal based at least in part on the voltage differences;
a data driver configured to i) apply the previous data voltages to the data lines during a time period which is one horizontal period before the current data voltages and ii) selectively perform a charge share operation or a precharge operation based at least in part on the charge share control signal, wherein the data driver is further configured to electrically connect at least two of the data lines to each other during the charge share operation, and wherein the data driver is further configured to apply the bias voltage to the data lines during the precharge operation; and
a timing controller configured to control the charge share controller and the data driver.

2. The display device of claim 1, wherein the data driver comprises a charge share controller that generates the charge share control signal.

3. The display device of claim 1, wherein the timing controller comprises a charge share controller that generates the charge share control signal.

4. The display device of claim 1, wherein the at least one bias voltage includes a positive bias voltage and a negative bias voltage and wherein the data driver is further configured to selectively apply the positive bias voltage or the negative bias voltage to each of the data lines based at least in part on a polarity of a corresponding current data voltage during the precharge operation.

5. The display device of claim 1, wherein the at least one bias voltage includes a plurality of positive bias voltages and a plurality of negative bias voltages and wherein the data driver is further configured to apply one of the positive bias voltages or one of the negative bias voltages to each of the data lines based at least in part on a polarity and a voltage level of a corresponding current data voltage during the precharge operation.

6. The display device of claim 1, wherein the data lines are divided into a plurality of data line groups each including N adjacent data lines, where N is an integer of two or more, and wherein the data driver is further configured to perform the same charge share operation or precharge operation for each of the data lines included in the same data line group.

7. The display device of claim 6, further comprising a charge share controller that generates the charge share control signal, wherein the charge share controller comprises:
a data voltage comparator configured to calculate the voltage difference between each of the current data voltages and the corresponding previous data voltages; and
an initialization decision unit configured to generate the charge share control signal for each of the data line groups based at least in part on the voltage differences.

8. The display device of claim 7, wherein the data voltage comparator comprises:
a memory configured to store the previous image data received in a time period which is one horizontal period before the current image data; and
an arithmetic unit configured to i) convert the current image data into the current data voltages using a look-up table memory, ii) convert the previous image data into the previous data voltages using the look-up table memory, and iii) calculate the voltage differences between the current data voltages and the previous data voltages.

9. The display device of claim 7, wherein the data driver is further configured to perform the charge share operation on one of the data line groups when each of the voltage differences between the previous and current data voltages applied to the data lines included in the one of the data line groups is less than a predetermined reference value.

10. The display device of claim 7, wherein the data driver is further configured to perform the precharge operation on one of the data line groups when at least one of the voltage differences between the previous and current data voltages applied to the data lines of the one of the data line groups is greater than a predetermined reference value.

11. The display device of claim 6, wherein the data driver comprises:
a plurality of digital-to-analog converters respectively connected to the data lines and configured to i) convert the current image data into the current data voltages and ii) output the current data voltages;
a plurality of precharge switches respectively connected to the data lines, wherein each of the precharge switches is configured to i) electrically connect a corresponding data line to a bias voltage line when the precharge operation is performed, ii) disconnect the corresponding data line so as to be open circuited when the charge share operation is performed, and iii) electrically connect the corresponding data line to a corresponding digital-to-analog converter after the precharge operation or the charge share operation has been completed; and
a plurality of charge share switches, wherein at least one of the charge share switches is arranged between the data lines included in each of the data line groups, wherein the at least one charge share switch is configured to electrically connect all the data lines included in the corresponding data line group to each other when the charge share operation is performed.

12. The display device of claim 11, wherein, when the charge share control signal corresponding to a selected one of the data line groups has a first logic level, the precharge switches corresponding to the selected data line group are configured to be open circuited and the at least one charge share switch is configured to electrically connect all the data lines included in the selected data line group.

13. The display device of claim 11, wherein, when the charge share control signal corresponding to a selected one of the data line groups has a second logic level, the precharge switches corresponding to the selected data line group are configured to apply the bias voltage to the corresponding data lines included in the selected data line group and the at least one charge share switch corresponding to the selected data line group is configured to be open circuited.

14. The display device of claim 11, wherein, when the charge share control signal corresponding to a selected one of the data line groups has a third logic level, the precharge switches corresponding to the selected data line group are configured to apply the current data voltages to the corresponding data lines of the selected data line group and the at least one charge share switch corresponding to the selected data line group is configured to be open circuited.

15. A method of operating a display device having a plurality of pixels electrically connected to a plurality of data lines, the method comprising:
generating at least one bias voltage;
calculating voltage differences between current data voltages associated with current image data and previous data voltages associated with previous image data;
generating at least one charge share control signal based at least in part on the voltage differences;
selectively performing i) a charge share operation that electrically connects at least two of the data lines to each other or ii) a precharge operation that applies the bias voltage to the data lines in response to the charge share control signal; and
applying the current data voltages to the data lines.

16. The method of claim 15, wherein the bias voltage includes a positive bias voltage and a negative bias voltage and wherein the precharge operation comprises selectively applying the positive bias voltage or the negative bias voltage to each of the data lines based at least in part on a polarity of a corresponding current data voltage.

17. The method of claim 15, wherein the bias voltage includes a plurality of positive bias voltages and a plurality of negative bias voltages and wherein the precharge operation comprises applying one of the positive bias voltages or one of the negative bias voltages to each of the data lines based at least in part on a polarity and a voltage level of a corresponding current data voltage.

18. The method of claim 15, wherein the data lines are divided into a plurality of data line groups including N adjacent data lines, where N is an integer of two or more, and wherein the selectively performing further comprises performing the same charge share operation or precharge operation for each of the data lines included in the same data line group.

19. The method of claim 18, wherein the calculating comprises:
storing the previous image data;
converting the current image data into the current data voltages;
converting the previous image data into the previous data voltages; and
calculating the voltage differences between the current data voltages and the previous data voltages.

20. The method of claim 18, wherein the generating of the at least one charge share control signal comprises generating a charge share control signal for each of the data line groups and wherein the generating of each of the charge share control signals comprises:
generating the charge share control signal having a first logic level to indicate that the charge share operation is to be performed on the corresponding data line group when all the voltage differences between the previous and current data voltages applied to the data lines included in the corresponding data line group are less than a predetermined reference value; and
generating the charge share control signal having a second logic level to indicate that the precharge operation is to be performed on the corresponding data line group when at least one of the voltage differences between previous and current data voltages applied to the data lines included in the corresponding data line group is greater than a predetermined reference value.

21. A display device, comprising:
a display panel including a plurality of pixels electrically connected to a plurality of data lines;
a controller configured to calculate voltage differences between current data voltages and previous data voltages; and
a data driver configured to apply data voltages to the data lines and selectively perform a charge share operation or a precharge operation based at least in part on the voltage differences,
wherein the data driver is further configured to electrically connect at least two of the data lines to each other during the charge share operation, and
wherein the data driver is further configured to apply a bias voltage to the data lines during the precharge operation.

22. The display device of claim 21, wherein the data lines are divided into a plurality of data line groups and wherein the data driver is further configured to selectively perform the same charge share operation or precharge operation to all of the data lines included in the same data line group.

23. The display device of claim 22, wherein the controller is further configured to determine if all of the voltage differences between the previous and current data voltages applied to the data lines included in a selected one of the data line groups are less than a predetermined reference value and wherein the data driver is further configured to selectively perform the charge share operation or the precharge operation based at least in part on the determination.

24. The display device of claim 21, wherein the data driver is further configured to apply the previous data voltages to the data lines during a time period which is one horizontal period before the current data voltages.
